(19) United States
(12) Patent Application Publication
(10) Pub. No.: US 2014/0368554 A1
(43) Pub. Date: Dec. 18, 2014

(54) STEREOSCOPIC IMAGE ENCODE DEVICE AND METHOD, AND STEREOSCOPIC IMAGE DECODE DEVICE AND METHOD

(71) Applicant: KABUSHIKI KAISHA TOSHIBA, Tokyo (JP)

(72) Inventors: Wataru ASANO, Yokohama-shi (JP); Tomoya KODAMA, Kawasaki-shi (JP)

(73) Assignee: KABUSHIKI KAISHA TOSHIBA, Tokyo (JP)

(21) Appl. No.: 14/163,255

(22) Filed: Jan. 24, 2014

(30) Foreign Application Priority Data
Jun. 18, 2013 (JP) 2013-127224

(51) Int. Cl. G06T 9/00; G09G 5/10

(52) U.S. Cl. CPC G06T 9/00; G09G 5/10
USPC 345/690

(57) ABSTRACT

According to an embodiment, a stereoscopic image encode device encodes a stereoscopic image displayed on a display device including a light control unit capable of controlling directions of light beams and including a display for emitting light beams from sub-pixels through the light control unit. The stereoscopic image encode device includes a determining unit, a generating unit, and an encoding unit. The determining unit configured to determine a method of dividing the stereoscopic image for each color component based on mapping information indicating the direction of emitted light beam from each sub-pixel, when the number of sub-pixels corresponding to a single cycle of the light control unit is not an integral multiple of the number of parallaxes in the stereoscopic image. The generating unit configure to generate a plurality of divided image. The encoding unit configured to encode each divided image.

### CROSS-REFERENCE TO RELATED APPLICATION(S)

This application is based upon and claims the benefit of priority from Japanese Patent Application No. 2013-127224, filed on Jun. 18, 2013; the entire contents of which are incorporated herein by reference.

### FIELD

Embodiments described herein relate generally to a stereoscopic image encode device and method, and a stereoscopic image decode device and method.

### BACKGROUND

There is a known type of display in which elements, such as lenticular lenses or parallax barriers, that control the directions of light beams are installed so as to enable stereoscopic viewing with the unaided eye. Moreover, a method is known for encoding a stereoscopic image that is to be output on the abovementioned type of display, and a method is known for decoding a stereoscopic image that has been encoded. However, in the conventional method of encoding a stereoscopic image; if the number of sub-pixels that emit light beams through, for example, a single lenticular lens is not an integral multiple of the number of parallaxes set with respect to a single lenticular lens, then the stereoscopic image cannot be encoded in an efficient manner.

### BRIEF DESCRIPTION OF THE DRAWINGS

FIG. 1 is a block diagram illustrating an exemplary configuration of a stereoscopic image encode device according to an embodiment;

FIG. 2 is a conceptual diagram that conceptually illustrates a first example of mapping information;

FIG. 3 is a conceptual diagram that conceptually illustrates a second example of the mapping information;

FIG. 4 is a flowchart for explaining the operations performed in the stereoscopic image encode device according to the embodiment;

FIG. 5 is a flowchart for explaining the details of the operations performed by a first determining unit for the purpose of determining a dividing method;

FIG. 6 is a graph illustrating an example of the relationship between the operations performed by the first determining unit and sub-pixels;

FIG. 7 is a diagram illustrating an example of sub-pixels of divided images that are divided according to the dividing method determined by the first determining unit;

FIG. 8 is a graph illustrating an example of the relationship between the operations performed by the first determining unit and the sub-pixels in a first modification example of a search range illustrated in FIG. 6;

FIG. 9 is a graph illustrating an example of the relationship between the operations performed by the first determining unit and the sub-pixels in a second modification example of a search range illustrated in FIG. 6;

FIG. 10 is a flowchart for explaining the details of the operations performed by a first generating unit for the purpose of generating divided images;

FIG. 11 is a flowchart for explaining a first example of detailed operations performed in the stereoscopic image encode device according to the embodiment;

FIG. 12 is a flowchart for explaining a second example of detailed operations performed in the stereoscopic image encode device according to the embodiment;

FIG. 13 is a diagram illustrating a specific example of encoded data generated in the stereoscopic image encode device according to the embodiment;

FIG. 14 is a block diagram illustrating an exemplary configuration of a stereoscopic image decode device according to the embodiment; and

FIG. 15 is a flowchart for explaining the operations performed in the stereoscopic image decode device according to the embodiment.

FIG. 16 is a diagram illustrating a hardware configuration of the stereoscopic image encode device 1 (and the stereoscopic image decode device 7) according to the embodiment.

### DETAILED DESCRIPTION

According to an embodiment, a stereoscopic image encode device encodes a stereoscopic image displayed on a display device including a light control unit capable of controlling directions of light beams in specific cycles and including a display for emitting light beams from a plurality of sub-pixels through the light control unit. The stereoscopic image encode device includes a determining unit, an generating unit, and an encoding unit. The determining unit configured to determine a method of dividing the stereoscopic image for each color component based on mapping information indicating the direction of emitted light meam from each sub-pixel, when the number of sub-pixels corresponding to a single cycle of the light control unit is not an integral multiple of the number of parallaxes in the stereoscopic image. The generating unit configured to generate a plurality of divided image into which the stereoscopic image is divided in accordance with the dividing method. The encoding unit configured to encode each divided image.

An embodiment is described below with reference to the accompanying drawings.

Stereoscopic Image Encode Device

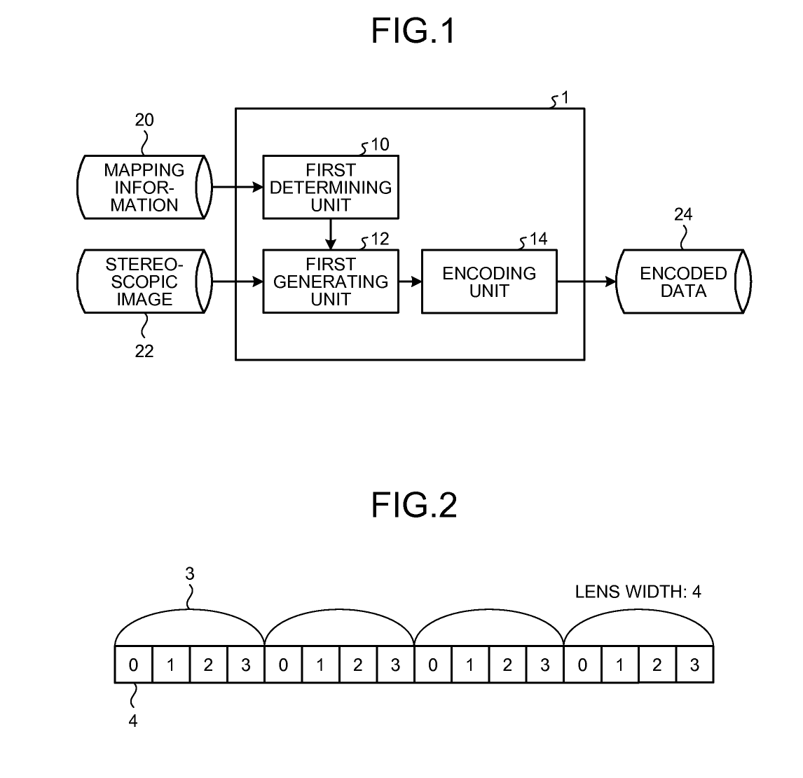

FIG. 1 is a block diagram illustrating an exemplary configuration of a stereoscopic image encode device 1 according to the embodiment. The stereoscopic image encode device 1 is implemented using, for example, a general-purpose computer. That is, the stereoscopic image encode device 1 functions as a computer that includes a central processing device (CPU), a memory device, and a communication interface. Moreover, the stereoscopic image encode device 1 is used in a television or a personal computer (PC) that enables stereoscopic viewing with the unaided eye.

As illustrated in FIG. 1, the stereoscopic image encode device 1 includes a first determining unit 10, a first generating unit 12, and an encoding unit 14. Herein, the first determining unit 10, the first generating unit 12, and the encoding unit 14 can either be implemented using hardware circuitry or be implemented using software executed in the CPU.

The first determining unit 10 obtains mapping information 20 from, for example, outside and determines a dividing method for dividing a stereoscopic image by referring to the mapping information 20. Herein, the mapping information 20 is based on the relationship between light beam control elements such as lenticular lenses, which are installed in a display device (not illustrated) that enables stereoscopic viewing with the unaided eye, and the sub-pixels of the display device. In the following explanation, it is assumed that the display device includes light beam control elements, which are capable of controlling the directions of light beams in specific cycles, and includes a display unit, which emits light beams from a plurality of sub-pixels through the light beam control elements.

FIG. 2 is a conceptual diagram that conceptually illustrates a first example of the mapping information 20. In FIG. 2 is illustrated an example of a display device in which four parallaxes (which have parallax numbers 0 to 3 assigned in the sequence and which represent values indicating four light beam emitting directions) are set using a plurality of lenticular lenses (light beam control elements) 3 arranged in a cyclic manner. Meanwhile, there are times when the parallaxes that are set do not perfectly match with the actual light beam emitting directions. Moreover, each of the lenticular lenses 3 is set to have the width equal to four sub-pixels 4. Furthermore, the number of parallaxes indicates the largest value from among the values that represent the light beam emitting directions specified in the mapping information 20. For example, if the number of parallaxes is four, it means that the light beam emitting directions are set in the range of zero to four.

Thus, in the mapping information 20 as a first example, it is specified that the light beam emitting direction is set for each sub-pixel, and that the number of sub-pixels which emit light beams through the lenticular lenses 3 is an integral multiple of the number of parallaxes set with respect to the lenticular lenses 3.

Using the mapping information 20 according to the first example, a stereoscopic image can be divided into images that are equal in number to the number of parallaxes (i.e., divided into four images), and each divided image can be encoded.

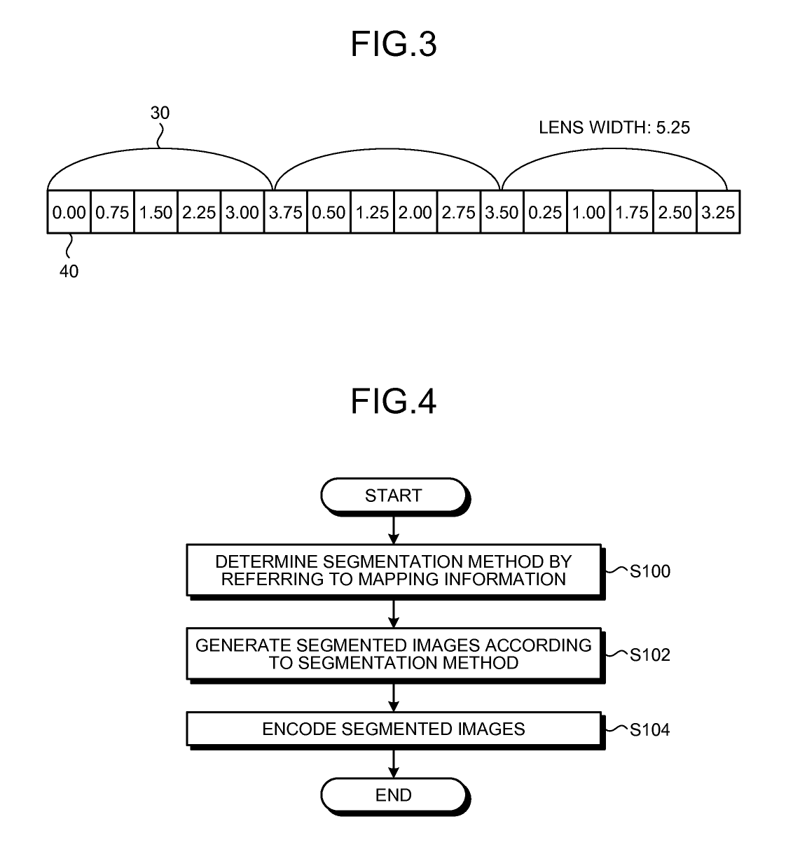

FIG. 3 is a conceptual diagram that conceptually illustrates a second example of the mapping information 20. In FIG. 3 is illustrated an example of a display device in which four parallaxes (which have parallax numbers 0 to 3 assigned in the sequence and which are values indicating four light beam emitting directions) are set using a plurality of lenticular lenses (light beam control elements) 30 arranged in a cyclic manner. Moreover, each of the lenticular lenses 30 is set to have the width equal to 5.25 sub-pixels 40. In the mapping information 20 as a second example, since the number of parallaxes is four, the light beam emitting directions are set in the range of zero to four as described above.

Thus, in the mapping information 20 according to the second example, it is specified that the light beam emitting direction is set for each sub-pixel, and that the number of sub-pixels which emit light beams via the lenticular lenses 30 is not an integral multiple of the number of parallaxes set with respect to the lenticular lenses 30 (i.e., the number of parallaxes set with respect to stereoscopic images).

Apart from that, there are times when the direction of arrangement of lenticular lenses is different than the direction of arrangement of sub-pixels (when the lenticular lenses are arranged in an inclined manner or in a bow-like manner). Moreover, there are times when the light beam emitting directions are not changed evenly in the sequence of parallax numbers.

If the mapping information 20 according to the second example is used without modification, then a stereoscopic image cannot be divided into images that are equal in number to the number of parallaxes (i.e., a stereoscopic image cannot be divided into four images). Hence, the stereoscopic image cannot be encoded in an efficient manner. Meanwhile, the mapping information 20 can be in the form a mapping table or a mathematical expression.

The first generating unit 12 (see FIG. 1) receives a stereoscopic image 22 from, for example, outside and generates divided images according to the dividing method determined by the first determining unit 10. The encoding unit 14 encodes (encodes) the divided images generated by the first generating unit 12 and generates encoded data 24.

Given below is the explanation of operations performed in the stereoscopic image encode device 1 for the purpose of obtaining the mapping information 20 according to the second example illustrated in FIG. 3 and then encoding the stereoscopic image 22.

FIG. 4 is a flowchart for explaining the operations performed in the stereoscopic image encode device 1. Firstly, the first determining unit 10 refers to the mapping information 20 (according to the second example), which contains the light beam emitting direction of each sub-pixel of a display device which enables stereoscopic viewing with the unaided eye, and determines the dividing method for dividing the stereoscopic image 22 (step S100).

Then, according to the dividing method determined by the first determining unit 10, the first generating unit 12 divides the stereoscopic image 22 into a plurality of divided images (step S102).

Subsequently, the encoding unit 14 encodes (encodes) the divided images, which are generated by the first generating unit 12, as, for example, continuous images that constitute a moving image; and generates the encoded data 24 (step S104).

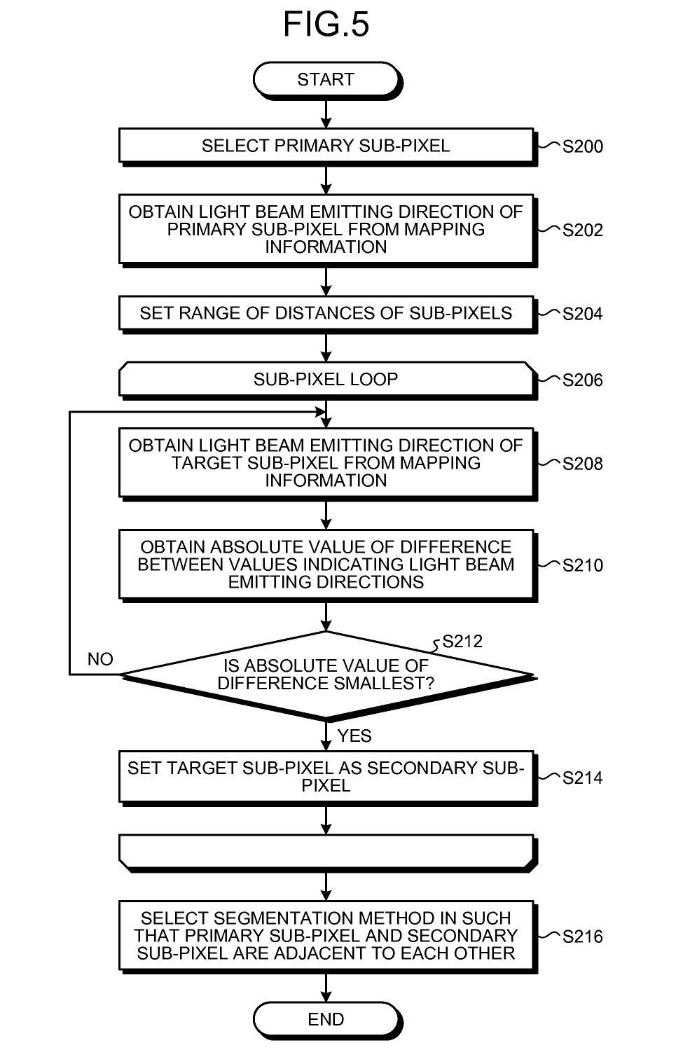

Given below is the detailed explanation about the operations performed by the first determining unit 10 for the purpose of determining the dividing method. FIG. 5 is a flowchart for explaining the details of the operations performed by the first determining unit 10 for the purpose of determining the dividing method.

Firstly, the first determining unit 10 selects a primary sub-pixel that serves as the reference sub-pixel (i.e., serves as the target sub-pixel) (step S200) and obtains the light beam emitting direction of the primary sub-pixel from the mapping information 20 (step S202). Then, the first determining unit 10 sets a range of distances of such sub-pixels which are candidates to be the adjacent sub-pixel of the primary sub-pixel (i.e., sets a search range in the direction of arrangement of sub-pixels) (step S204).

Then, the first determining unit 10 starts an operation (a sub-pixel loop) to determine a secondary sub-pixel that is suitable to be the adjacent sub-pixel to the primary sub-pixel in the divided images (step S206).

In the sub-pixel loop, the first determining unit 10 obtains, from the mapping information 20, the light beam emitting direction of each sub-pixel present within the range of distances set at step S204 (step S208). Then, the first determining unit 10 obtains the absolute value of the difference between a value indicating the light beam emitting direction of the primary sub-pixel and a value indicating the light beam emitting direction of a target sub-pixel (step S210).

The first determining unit 10 determines whether or not the absolute value of the difference obtained at step S210 is the smallest within the range of distances obtained at step S204 (step S212). If the absolute value is not the smallest, then it proceeds to step S208. On the other hand, if the absolute value is the smallest, then it proceeds to step S214. Regarding the determination about whether or not the absolute value of the difference between values indicating the light beam emitting directions is the smallest within the range of distances obtained step at 5204, the first determining unit 10 may take into account the fact that the values (parallax numbers) in the light beam emitting directions cyclically change within a specific range, and accordingly perform the determination.

The first determining unit 10 sets, as the secondary sub-pixel, a target sub-pixel for which the absolute value of the difference between a value indicating the light beam emitting direction of the primary sub-pixel and a value indicating the light beam emitting direction of the target sub-pixel is the smallest within the range of distances set at step S204 (step S214).

Subsequently, the first determining unit 10 selects and determines such a dividing method that the images are thinned out so as to make the primary sub-pixel and the secondary sub-pixel to be adjacent sub-pixels (step S216).

Herein, if “n” represents the distance (i.e., the number of sub-pixels) between the primary sub-pixel and the secondary sub-pixel; then the stereoscopic image 22 is divided into n number of images. Thus, regarding a divided image a (where “a” is an integer satisfying 0<n and 0≦a<n); sub-pixels having nx+a (wherein x is an integer) as the respective coordinate in the stereoscopic image are assigned to the divided image a.

Meanwhile, at step S212 illustrated in FIG. 5, with respect to each sub-pixel present within the range of distances set at step S204, the first determining unit 10 can determine whether or not the absolute value of the difference between values indicating the light beam emitting directions is equal to or smaller than a predetermined upper threshold value (such as 0.5) and can accordingly determine whether or not to set the sub-pixel as the secondary sub-pixel.

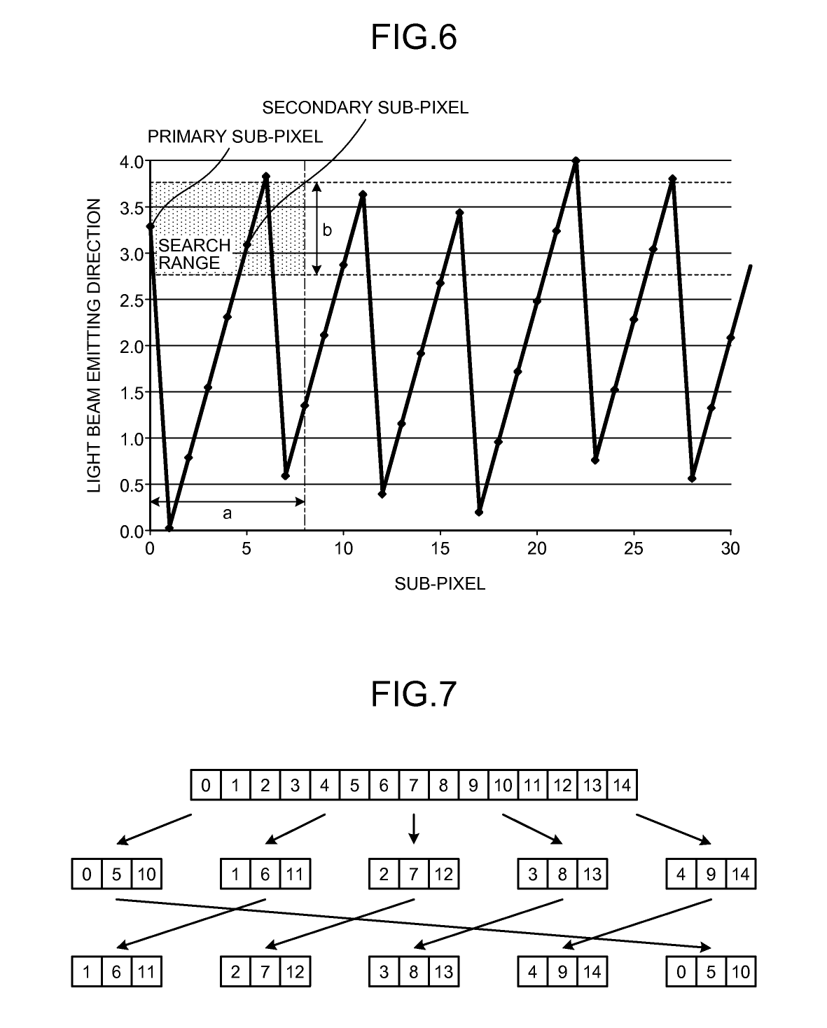

FIG. 6 is a graph illustrating an example of the relationship between the operations performed by the first determining unit 10 and the sub-pixels. FIG. 7 is a diagram illustrating an example of sub-pixels of the divided images that are divided according to the dividing method determined by the first determining unit 10. As illustrated in FIG. 6, for example, the first determining unit 10 sets the sub-pixel on the extreme left (the 0-th sub-pixel) as the primary sub-pixel and sets the range of distances of target sub-pixels (i.e., the search range in the direction of arrangement of sub-pixels: a) to be equal to 8. In this case, since the absolute value of the difference between a value indicating the light beam emitting direction of the 0-th sub-pixel and a value indicating the light beam emitting direction of the 5-th sub-pixel is the smallest, the first determining unit sets the 5-th sub-pixel as the secondary sub-pixel. Once the 5-th sub-pixel is set as the secondary sub-pixel, the first determining unit 10 determines a dividing method by which the stereoscopic image 22 is divided into five images as illustrated in FIG. 7 so as to ensure that the 0-th sub-pixel and the 5-th sub-pixel become adjacent sub-pixels.

Moreover, as described above, the first determining unit 10 may determine the secondary sub-pixel within a search range that is enclosed between the range of distances (illustrated by “a” in FIG. 6) of target sub-pixels and the upper threshold value of the absolute values of the differences between values indicating the light beam emitting directions (i.e., a range illustrated by “b” in FIG. 6). In this case, for example, the first determining unit 10 sets the sub-pixel on the extreme left (the 0-th sub-pixel) as the primary sub-pixel; sets the range of distances of target sub-pixels to be equal to 8; and sets the upper threshold value of the absolute values of the differences between values indicating the light beam emitting directions to be equal to or smaller than 0.5. Consequently, the 5-th sub-pixel satisfies the conditions and is set as the secondary sub-pixel.

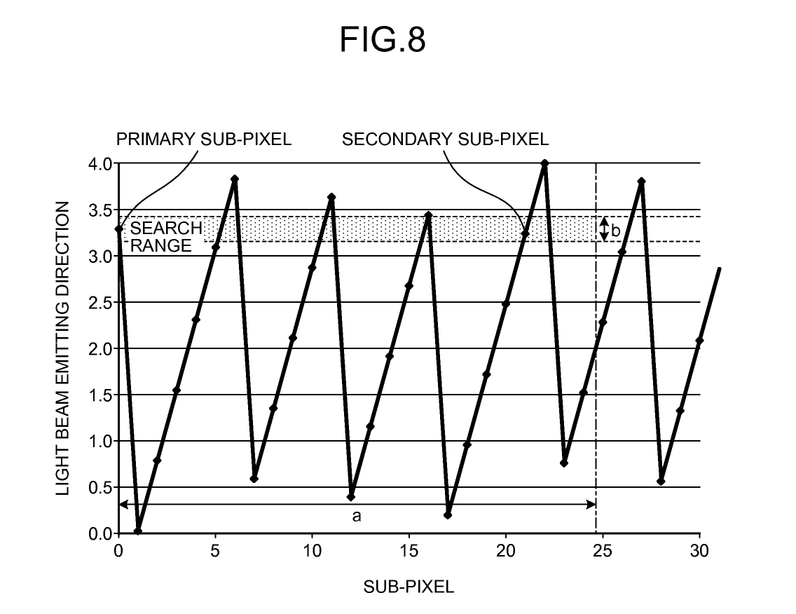

FIG. 8 is a graph illustrating an example of the relationship between the operations performed by the first determining unit 10 and the sub-pixels in a first modification example of the search range illustrated in FIG. 6. As illustrated in FIG. 8, for example, the first determining unit 10 sets the sub-pixel on the extreme left (the 0-th sub-pixel) as the primary sub-pixel; sets the range of distances of target sub-pixels to be equal to 24; and sets the upper threshold value of the absolute values of the differences between values indicating the light beam emitting directions to be equal to or smaller than 0.125. Consequently, the 21-st sub-pixel satisfies the conditions and is set as the secondary sub-pixel.

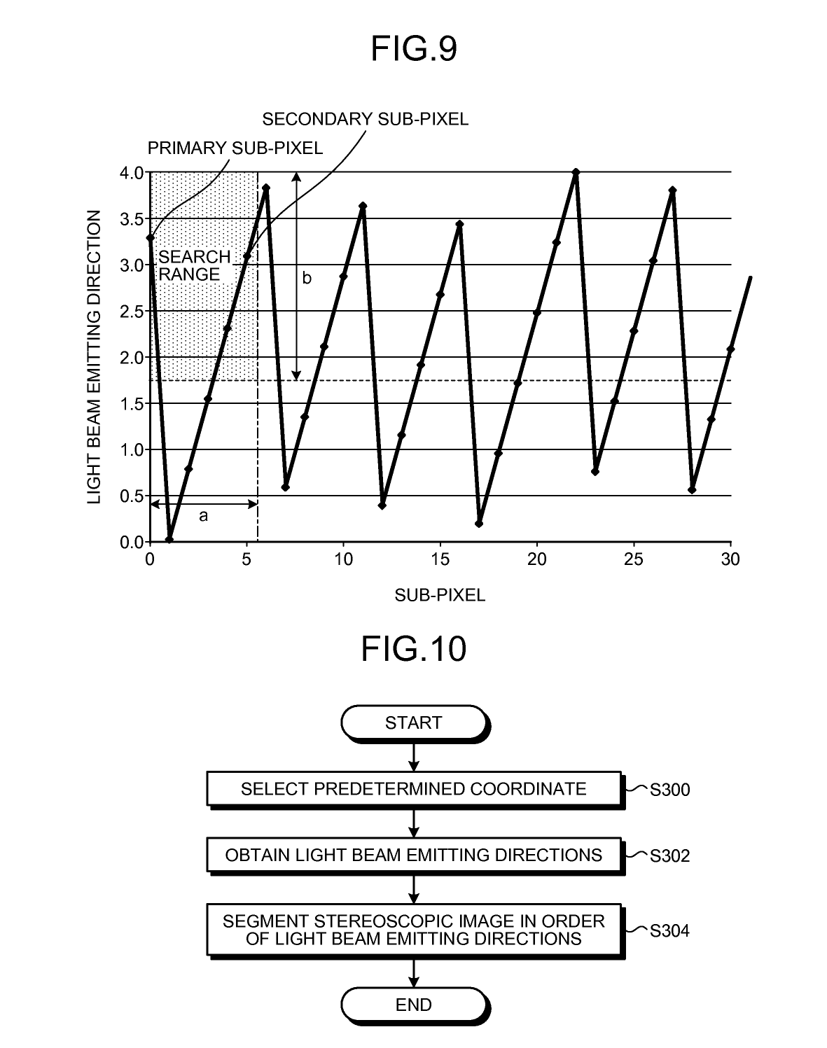

FIG. 9 is a graph illustrating an example of the relationship between the operations performed by the first determining unit 10 and the sub-pixels in a second modification example of the search range illustrated in FIG. 6. As illustrated in FIG. 9, for example, the first determining unit 10 sets the sub-pixel on the extreme left (the 0-th sub-pixel) as the primary sub-pixel; sets the range of distances of target sub-pixels to be equal to 5; and sets the upper threshold value of the absolute values of the differences between values indicating the light beam emitting directions to be equal to or smaller than 1.5. Consequently, the 4-th sub-pixel and the 5-th sub-pixel satisfy the conditions. In this case, the 5-th sub-pixel has the smallest absolute value of the difference between values indicating the light beam emitting directions. Hence, the first determining unit 10 sets the 5-th sub-pixel as the secondary sub-pixel.

Meanwhile, the dividing method described above is represented in a unidimensional manner. However, in practice, the first determining unit 10 determines the secondary sub-pixel with respect to the horizontal direction as well as with respect to the vertical direction, and determines a dividing method for dividing the stereoscopic image 22 lengthwise and breadthwise. Moreover, in addition to the horizontal direction and the vertical direction, the first determining unit 10 can set the range of sub-pixels also in an oblique direction. Alternatively, the first determining unit 10 can set the range of sub-pixels in a quadrangular manner. Particularly, when the light beam control elements are lenses such as lenticular lenses serving as inclined lenses, the dividing method may be implemented along that inclined direction.

Given below is the explanation of operations performed by the first generating unit 12 for the purpose of generating divided images. FIG. 10 is a flowchart for explaining the details of the operations performed by the first generating unit 12 for the purpose of generating divided images.

Firstly, the first generating unit 12 selects a predetermined coordinate in post-dividing images (step S300). Then, the first generating unit 12 obtains, from the mapping information 20, the light beam emitting direction from the sub-pixel present at the selected coordinate in each divided image (step S302). Subsequently, the first generating unit 12 divides the stereoscopic image 22 in ascending or descending order of the light beam emitting directions (step S304).

For example, when the light beam emitting direction of each sub-pixel is mapped in the mapping information 20 as illustrated in FIG. 6, the number of divisions of the stereoscopic image 22 is five. Then, the first generating unit 12 sets the post-dividing extreme left sub-pixel (the 0-th sub-pixel) as the predetermined coordinate, and sequentially generates divided images to which the sub-pixels in the stereoscopic image 22 are assigned in the order of 1-st sub-pixel→2-nd sub-pixel→3-rd sub-pixel→4-th sub-pixel→0-th sub-pixel (i.e., in the order of closer light beam emitting directions).

Once the first generating unit 12 divides the stereoscopic image 22, the encoding unit 14 implements an encoding method including inter prediction; performs encoding with the divided images to be encoded as reference images; and generates the encoded data 24. Moreover, as described later, the encoding unit 14 considers the images of the same color component as the reference images. Meanwhile, it is efficient and desirable to use RGB as the color coordinate system.

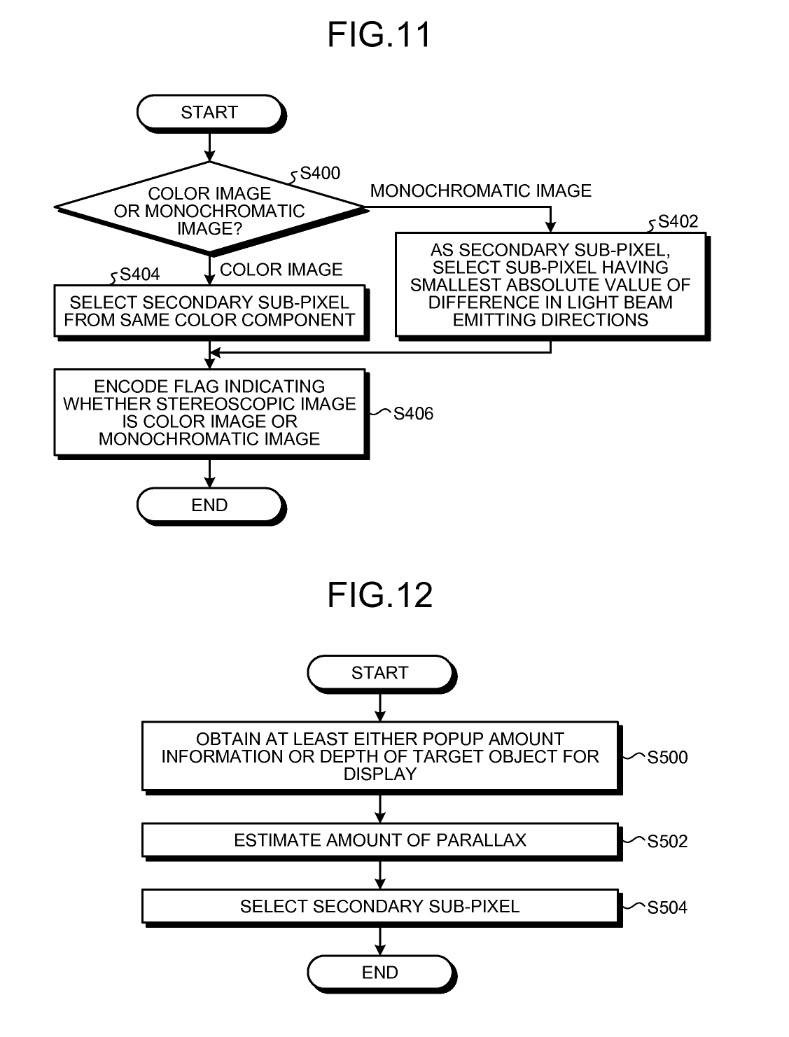

Given below is the explanation of further detailed operations performed in the stereoscopic image encode device 1. FIG. 11 is a flowchart for explaining a first example of detailed operations performed in the stereoscopic image encode device 1. Firstly, the first determining unit 10 determines whether the stereoscopic image 22 is a color image or a monochromatic image (step S400). If the stereoscopic image 22 is a color image, then the first determining unit 10 selects the secondary sub-pixel from among the sub-pixels having the same color component as the color component of the primary sub-pixel (step S404).

On the other hand, if the stereoscopic image 22 is a monochromatic image, then the first determining unit 10 selects, as the secondary sub-pixel, the sub-pixel having the smallest absolute value of the difference between a value indicating the light beam emitting direction thereof and a value indicating the light beam emitting direction of the primary sub-pixel (step S402). That is, when the stereoscopic image 22 is a monochromatic image, the first determining unit 10 considers that all sub-pixels have the same color component.

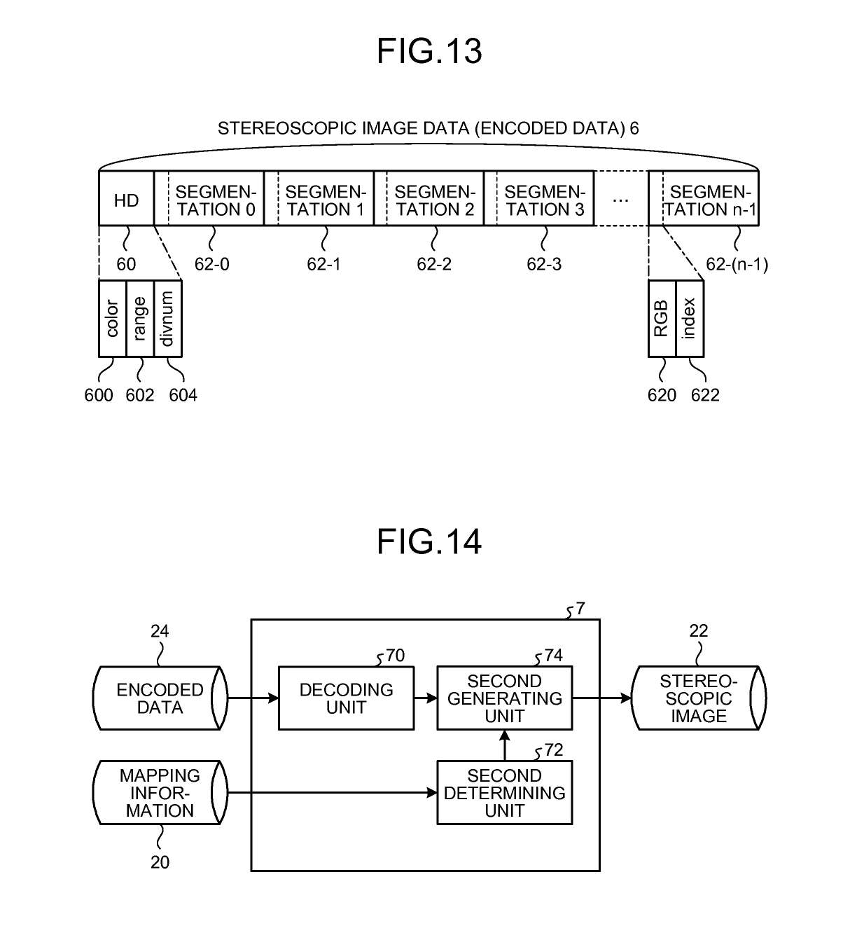

Then, the encoding unit 14 further encodes information (for example, a flag: see FIG. 13) indicating whether the stereoscopic image 22 is a color image or a monochromatic image (step S406).

In this way, the operations performed in the stereoscopic image encode device 1 vary depending on whether the stereoscopic image 22 is a color image or a monochromatic image. For example, if the sub-pixels in a display device are arranged in the order of R→G→B→R→G→B→ . . . and so on, then the stereoscopic image 22 to be encoded is a color image. If the primary sub-pixel is an R sub-pixel, then the first determining unit 10 performs selection to ensure that the secondary sub-pixel is also an R sub-pixel. Thus, the distance between the primary sub-pixel and the secondary sub-pixel and the number of image divisions are multiples of 3. Then, the post-divided images include an image having only the R component, an image having only the G component, and an image having only the B component. On the other hand, if the stereoscopic image 22 to be encoded is a monochromatic image, then the color component of the primary sub-pixel may be different than the color component of the secondary sub-pixel. That is because, as described above, the first determining unit 10 considers that all sub-pixels have the same color component.

FIG. 12 is a flowchart for explaining a second example of detailed operations performed in the stereoscopic image encode device 1. Firstly, the first determining unit 10 obtains at least either popup amount information of the display device that is capable of enabling stereoscopic viewing of the stereoscopic image 22 with the unaided eye or the depth (the difference between the nearest point and the furthest point) of an object that is being attempted to be displayed in the stereoscopic image (step S500).

Then, by referring to the obtained information, the first determining unit 10 estimates the amount of parallax of the stereoscopic image 22 (step S502). Subsequently, the first determining unit 10 selects the secondary sub-pixel in such a way that, greater the estimated amount of parallax, smaller becomes the difference between a value indicating the light beam emitting direction of the primary sub-pixel and a value indicating the light beam emitting direction of the secondary sub-pixel (step S504).

The operations illustrated in FIG. 12 are performed to determine the sub-pixel to be set as the secondary sub-pixel when a plurality of secondary sub-pixel candidates is present. In order to enhance the inter-pixel correlation among the divided images and to raise the encode efficiency, it is desirable that not only the distance between the primary sub-pixel and the secondary sub-pixel is short but also the absolute value of the difference between a value indicating the light beam emitting direction of the primary sub-pixel and a value indicating the light beam emitting direction of the secondary sub-pixel is small. However, there are times when a plurality of secondary sub-pixel candidates is present; and some of the candidates have a short distance to the primary sub-pixel but have a large difference between a value indicating the light beam emitting direction thereof and a value indicating the light beam emitting direction of the primary sub-pixel, while some of the candidates have a small difference between a value indicating the light beam emitting direction thereof and a value indicating the light beam emitting direction of the primary sub-pixel but have a large distance to the primary sub-pixel.

In such a case, if the amount of parallax is small; then, even when the difference in the light beam emitting directions is large, the difference in appearance is small. Hence, as the secondary sub-pixel, it is better to select a secondary sub-pixel candidate that has a short distance from the primary sub-pixel. Conversely, if the amount of parallax is large, then the difference in the light beam emitting directions has a huge effect on the difference in appearance. Hence, if a secondary sub-pixel candidate has a small difference between a value indicating the light beam emitting direction thereof and a value indicating the light beam emitting direction of the primary sub-pixel, then it is better to select that secondary sub-pixel candidate as the secondary sub-pixel even if the distance to the primary sub-pixel is somewhat long.

Given below is the explanation of a specific example of the encoded data generated in the stereoscopic image encode device 1. FIG. 13 is a diagram illustrating a specific example of the encoded data generated in the stereoscopic image encode device 1. As illustrated in FIG. 13, for example, encoded data 6 contains a header portion (HD) 60 and contains n number of sets of divided image data 62-0 to 62-(n−1).

The header portion 60 includes a first information (color) 600, a second information (range) 602, and a third information (divnum) 604. The first information 600 indicates whether the stereoscopic image 22 is a color image or a monochromatic image. The second information 602 indicates the range of distances of target sub-pixels. The third information 604 indicates the number of divided images.

Each of a plurality of pieces of divided image data 62-0 to 62-(n−1) contains a fourth information (RGB) 620 and a fifth information (index) 622. The fourth information 620 indicates the color component of the corresponding divided image. The fifth information (index) 622 indicates the position of the corresponding divided image in the stereoscopic image 22.

As illustrated in FIG. 13, when the encoded data 6 contains the header portion 60 and n number of pieces of divided image data 62-0 to 62-(n−1), the range for searching the secondary sub-pixel and the number of divisions for generating divided images is also input along with divided image data to a stereoscopic image decode device. Meanwhile, the encoding unit 14 can perform encoding of the number of divisions in the horizontal direction as well as the number of divisions in the vertical direction, or can perform encoding of the number of divisions in any one of the horizontal direction and the vertical direction, or can perform encoding of the total number of divisions obtained by multiplying the number of divisions in the horizontal direction and the number of divisions in the vertical direction.

If the header portion 60, the fourth information 620, and the fifth information 622 are shared among the stereoscopic image encode device 1 and a stereoscopic image decode device, then such information may not be included in the encoded data 6.

In this way, in the stereoscopic image encode device 1, the method of dividing a stereoscopic image is determined for each color component based on the mapping information. Hence, a stereoscopic image can be divided into a plurality of images having a high degree of space correlation. Thus, even in the case when the number of sub-pixels, which emit light beams through light beam control elements that form parallaxes in a display device, is not an integral multiple of the number of parallaxes set with respect to the light beam control elements; it still becomes possible to encode a stereoscopic image in an efficient manner.

Stereoscopic Image Decode Device

Given below is the explanation of a stereoscopic image decode device that decodes the encoded data 24 (or the encoded data 6) which has been encoded in the stereoscopic image encode device 1. FIG. 14 is a block diagram illustrating an exemplary configuration of a stereoscopic image decode device 7 according to the embodiment. The stereoscopic image decode device 7 is implemented using, for example, a general-purpose computer. That is, the stereoscopic image decode device 7 functions as a computer that includes a central processing device (CPU), a memory device, and a communication interface. Moreover, the stereoscopic image decode device 7 is used in a television or a personal computer (PC) that enables stereoscopic viewing with the unaided eye.

As illustrated in FIG. 14, the stereoscopic image decode device 7 includes a decoding unit 70, a second determining unit 72, and a second generating unit 74. The decoding unit 70, the second determining unit 72, and the second generating unit 74 can either be implemented using hardware circuitry or be implemented using software executed in the CPU.

The second determining unit 72 refers to the mapping information 20 and determines a dividing method for dividing the stereoscopic image 22. The decoding unit 70 decodes the encoded data 24 and obtains divided images. The second generating unit 74 generates the stereoscopic image 22 from the divided images.

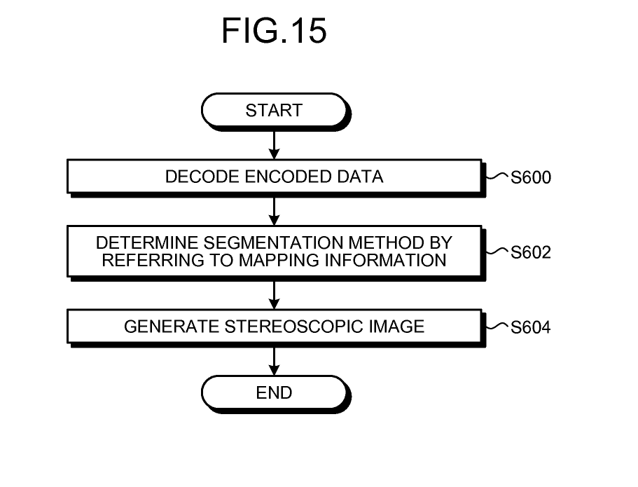

FIG. 15 is a flowchart for explaining the operations performed in the stereoscopic image decode device 7. The decoding unit 70 decodes the encoded data 24 and obtains a plurality of divided images (step S600). The second determining unit 72 determines the dividing method based on the mapping information 20, which indicates the light beam emitting direction of each sub-pixel of a display device that enables stereoscopic viewing with the unaided eye (step S602). The operation at step S602 is identical to the operation performed in the stereoscopic image encode device 1 that is operating in pairs. Thus, if the mapping information 20 is same, it results in the determination of the same dividing method. Besides, a flag indicating whether the encoded data contains a color image or a monochromatic image, and the operation of determining the dividing method according to the amount of parallax are also same to the stereoscopic image encode device 1.

The second generating unit 74 combines a plurality of divided images according to the dividing method, and generates the stereoscopic image 22 (step S604). Thus, the operation performed at step S604 is opposite to the operation of generating divided images from the stereoscopic image 22 that is performed in the stereoscopic image encode device 1 which is operating in pairs.

Meanwhile, the operation at step S602 can be performed prior to the operation at step S601 or can be performed simultaneously to the operation at step S601.

In this way, in the stereoscopic image decode device 7, the method of dividing a stereoscopic image is determined for each color component based on the mapping information. Thus, even in the case when the number of sub-pixels, which emit light beams through light beam control elements that form parallaxes in a display device, is not an integral multiple of the number of parallaxes set with respect to the light beam control elements; it still becomes possible to decode a stereoscopic image in an efficient manner.

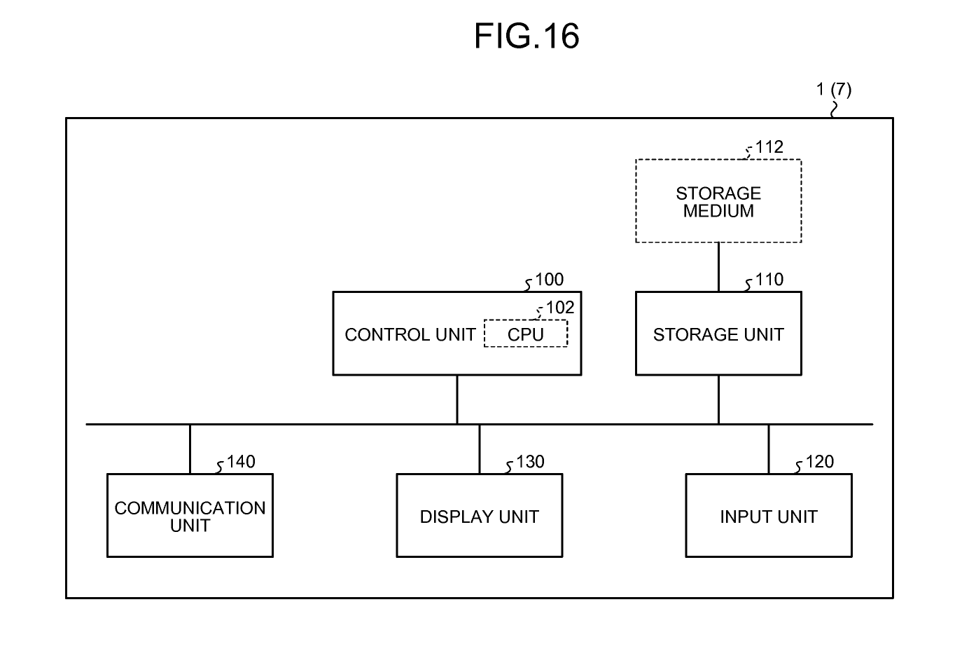

FIG. 16 is a diagram illustrating a hardware configuration of the stereoscopic image encode device 1 (and the stereoscopic image decode device 7) according to the embodiment. As illustrated in FIG. 16, the stereoscopic image encode device 1 (and the stereoscopic image decode device 7) includes a control unit 100, a storage unit 110, an input unit 120, a display unit 130, and a communication unit 140.

The control unit 100 includes, for example, a central processing unit (CPU) 102, and controls respective components constituting the stereoscopic image encode device 1.

The storage unit 110 includes a read only memory (ROM), a random access memory (RAM), and the like, which are not illustrated in the drawing, and stores therein a program executed by the control unit 100, data used for the control unit 100 to execute a program, and the like. Further, a storage medium 112 such as a memory card having a function of transmitting/receiving a program and data to/from the storage unit 110 is detachably attached to the stereoscopic image encode device 1.

The input unit 120 includes, for example, an input key or a switch, and receives a user's input to the stereoscopic image encode device 1. The display unit 130 is a liquid crystal panel, for example. The input unit 120 may be integrated with the display unit 130 through a touch panel.

The communication unit 140 includes a general-purpose interface that performs communication with the outside, and is configured to be connectable to, for example, any one of wired communication, long-distance wireless communication, and near field communication (NFC).

Herein, all or a part of the stereoscopic image encode device 1 (and the stereoscopic image decode device 7) can be implemented in a hardware circuitry.

Meanwhile, a encode program executed in the stereoscopic image encode device 1 as well as an decode program executed in the stereoscopic image decode device 7 is recorded in the form of an installable or executable file in a computer-readable recording medium such as a compact disk read only memory (CD-ROM), a flexible disk (FD), a compact disk readable (CD-R), or a digital versatile disk (DVD); and can be provided as a computer program product.

Alternatively, the encode program executed in the stereoscopic image encode device 1 as well as the decode program executed in the stereoscopic image decode device 7 can be saved as a downloadable file on a computer connected to the Internet or can be made available for distribution through a network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A stereoscopic image encode device that encodes a stereoscopic image to be displayed on a display device including a light control unit capable of controlling directions of light beams in specific cycles and a display for emitting light beams from a plurality of sub-pixels, the stereoscopic image encode device comprising:
a determining unit configured to determine a method of dividing the stereoscopic image for each color component based on mapping information indicating the direction of emitted light beam from each sub-pixel, when the number of sub-pixels corresponding to a single cycle of the light control unit is not an integral multiple of the number of parallaxes in the stereoscopic image;
a generating unit configured to generate a plurality of divided images into which the stereoscopic image is divided in accordance with the dividing method; and
an encoding unit configured to encode each divided image.

2. The device according to claim 1, wherein, the determining unit determines the dividing method so that each divided image includes pixels having similar mapping information.

3. The device according to claim 1, wherein the determining unit determines the dividing method so that a certain sub-pixel is arranged adjacent to a target sub-pixel in the divided image, the certain sub-pixel placed within a predetermined distance from the target sub-pixel in the stereoscopic image, and having the mapping information proximate to that of the target sub-pixel.

4. The device according to claim 1, wherein the generating unit generates the divided image so that values indicating directions of emission of light beams of sub-pixels are arranged either in ascending order or in descending order.

5. The device according to claim 1, wherein, when the stereoscopic image is a monochromatic image, the determining unit considers that all sub-pixels have same color component.

6. The device according to claim 1, wherein the encoding unit further encodes information indicating whether the stereoscopic image is a color image or a monochromatic image.

7. The device according to claim 1, wherein the encoding unit further encodes at least one of the range of distances, the number of the plurality of divided image, color component information of each divided image, or position information of each divided image.

8. The device according to claim 2, wherein, based on at least either popup amount information of the display device or a difference between the nearest point and the furthest point of a target object for display, the determining unit determines the dividing method to divide the stereoscopic image by widening the range of distances in proportion to the amount of parallax.

9. The device according to claim 1, wherein the encoding unit implements an encoding method including inter prediction and sets, as a reference image, a divided image having same color component as a divided image to be encoded.

10. The device according to claim 1, wherein the determining unit obtains the mapping information from outside.

11. A stereoscopic image decode device that decodes encoded data of a stereoscopic image displayed on a display device which includes a light control unit capable of controlling directions of light beams in specific cycles and includes a display for emitting light beams from a plurality of sub-pixels through the light control unit, the stereoscopic image decode device comprising:
a decoding unit configured to decode the encoded data to obtain a plurality of divided image;
a determining unit configured to, based on mapping information in which the direction of emission of a light beam from each sub-pixel of the display device is set, determine a dividing method to divide the stereoscopic image for each color component; and
a generating unit configured to, based on the dividing method, generate the stereoscopic image from the plurality of divided image.

12. The device according to claim 11, wherein, the determining unit determines the dividing method so that each divided image includes pixels having similar mapping information.

13. The device according to claim 11, wherein the determining unit determines the dividing method so that a certain sub-pixel is arranged adjacent to a target sub-pixel in the divided image, the certain sub-pixel placed within a predetermined distance from the target sub-pixel in the stereoscopic image, and having the mapping information proximate to that of the target sub-pixel.

14. The device according to claim 11, wherein the generating unit generates the stereoscopic image so that values indicating directions of emission of light beams of sub-pixels are arranged either in ascending order or in descending order.

15. The device according to claim 11, wherein, when the stereoscopic image is a monochromatic image, the determining unit considers that all sub-pixels have same color component.

16. The device according to claim 11, wherein the decoding unit further decodes information indicating whether the stereoscopic image is a color image or a monochromatic image.

17. The device according to claim 11, wherein the decoding unit further encodes at least one of the range of distances, the number of the plurality of divided image, color component information of each divided image, or position information of each divided image.

18. The device according to claim 12, wherein, based on at least either popup amount information of the display device or a difference between the nearest point and the furthest point of a target object for display, the determining unit determines the dividing method to divide the stereoscopic image by widening the range of distances in proportion to the amount of parallax.

19. The device according to claim 11, wherein the decoding unit implements an decoding method including inter prediction and sets, as a reference image, a divided image having same color component as a divided image to be decoded.

20. A stereoscopic image encode method for encoding a stereoscopic image displayed on a display device which includes a light control unit capable of controlling directions of light beams in specific cycles and includes a display for emitting light beams from a plurality of sub-pixels through the light control unit, the stereoscopic image encode method comprising:
determining, when the number of sub-pixels corresponding to a single cycle of the light control unit is not an integral multiple of the number of parallaxes set with respect to the stereoscopic image, a dividing method to divide the stereoscopic image for each color component based on mapping information in which the direction of emission of a light beam from each sub-pixel is set;
generating, a plurality of divided image from the stereoscopic image based on the dividing method; and
encoding the plurality of divided image.
